(19) United States
(12) Patent Application Publication
(10) Pub. No.: US 2002/0194269 A1
(43) Pub. Date: Dec. 19, 2002

(54) Distributed processing system, distributed processing method and client terminal capable of using the method

(76) Inventors: Yutaka Owada, Tokyo (JP); Shinnosuke Asahara, Tokyo (JP)

Correspondence Address: R. Neil Sudol, COLEMAN SUDOL SAPONE, P.C., 714 Colorado Avenue, Bridgeport, CT, 06605-1610, US

(21) Appl. No.: 10/152,243

(22) Filed: May 20, 2002

(30) Foreign Application Priority Data
Jun. 18, 2001 (JP) 2001-184158

(51) Int. Cl. G06F 15/16

(52) U.S. Cl. 709/203

(57) ABSTRACT

In the distributed processing system, a user terminal receives an event information generated in the other user terminals and transmitted from a server. During a period that the event information is transmitted in a network, a model in a processing server becomes already different from a model in the user terminal. Then, a state change compensation portion (210) continuously changes a state of a model processed in a processing portion (208) so that it becomes the same as the state of the model in the processing server, whereby an influence of delay generated by a communication can be reduced.

### BACKGROUND OF THE INVENTION

1. Field of the Invention

The present invention relates to a distributed processing technology. The invention particularly relates to a distributed processing system for simulating an event changing with time, a client terminal capable of being used in the distributed processing system, and a distributed processing method capable of being used in the distributed processing system.

2. Description of the Conventional Art

In these days, an infrastructure of a network communication is being improved, and an environment in which communication with a remote user can be taken via a network is being established. A so-called network game capable of playing with a remote user with staying at home by using the environment mentioned above receives popularity. Conventionally, in the network game utilizing an internet or the like, the structure is made such that each of clients connects a server providing a game environment and plays with the other clients in a game space developed in the server.

However, the communication between the client and the server is not made in a moment of time, and the client has to prepare himself or herself for a certain degree of delay. In the case of a game which requires no real-time drawing process and no quick response, such as a card game, an othello or the like, this delay time is not so much important, however, in the case of a game which requires a very high-speed drawing process and response, such as a shooting game, a racing game or the like, only a little delay sometimes gives the user an unnatural impression. In particular, for the user utilizing a network having an inferior circuit quality, this is a fatal problem.

### SUMMARY OF THE INVENTION

The present invention is made by taking the problems mentioned above into consideration, and an object of the present invention is to provide a technique of reducing an influence of delay generated by communication, in a distributed processing system.

An aspect in accordance with the present invention relates to a distributed processing system. The distributed processing system is a distributed processing system including a server and a plurality of client terminals and simulating an event changing with time, in which when “first” denotes structures relating to the server and “second” denotes structures relating to the client terminals, the server controls the event, the client terminals simulate the event and output information concerning the event to users, the client terminal includes a second transmission portion informing the server of a change of the event generated by operation of the users, the server includes a first receiving portion receiving the change informed from a plurality of client terminals, a first processing portion simulating the event on the basis of the change, and a first transmission portion informing the respective client terminals of the change informed from one client terminal, and the client terminals includes a second receiving portion receiving the change from the server, a second processing portion simulating the event on the basis of the change, and a state change compensating portion computing a state of the event in the first processing portion on the basis of a delay time at the time when the change is informed from the server to the client terminals and continuously changing the state of the event so as to synchronize the state of the event in the second processing portion with the state of the event in the first processing portion.

In this distributed processing system, both of the server and the respective client terminals simulate the event. Accordingly, the server acquires all the information concerning the change of the event generated in the respective client terminals and broadcasts the information to the respective client terminals, thereby synchronizing. At this time, there is a case that the event discontinuously changes due to the delay generated by the communication between the server and the client terminals, however, unnaturalness is reduced by compensating so that the discontinuous event becomes a continuous change.

Another aspect in accordance with the present invention relates to a distributed processing system. The distributed processing system is a distributed processing system including a server and a plurality of client terminals and simulating an event changing with time, in which when “first” denotes structures relating to the server and “second” denotes structures relating to the client terminals, the server controls the event, the client terminals simulate the event and output information concerning the event to users, the client terminal includes a second transmission portion informing the server of a change of the event generated by operation of the users, the server includes a first receiving portion receiving the change informed from a plurality of client terminals, a first processing portion simulating the event on the basis of the change, and a first transmission portion informing the respective client terminals of the change informed from one client terminal, and the client terminals includes a second receiving portion receiving the change from the server, a second processing portion simulating the event on the basis of the change, and a time compensating portion quickening a time advance so as to catch up with a common time used in the first processing portion during the time until a predetermined time has passed after setting back a local time used in the second processing portion at the time of receiving the change, at a delay time at the time when the change is informed from the server to the client terminals. As an example of the common time, a world time may be employed.

In this distributed processing system, in order to compensate a time lag caused by the delay generated by the communication between the server and the client terminals, the structure is made such that the local time of the client terminal is once set back to the time at which the change of the event is generated, and the time advance thereafter is quickened so as to catch up with the common time.

The distributed processing system may further include a state change compensating portion computing a state of the event in the first processing portion on the basis of the delay time and continuously changing the state of the event in the second processing portion to a state of the event in the first processing portion.

In the client terminal, the second processing portion may reflect the change on the simulation before receiving the change of the event generated by the operation of the user, from the server. Since the respective client terminals respectively simulate the event, it is possible to reflect the change of the event generated in its own terminal in real time.

The other aspect in accordance with the present invention relates to a client terminal. The client terminal is a client terminal simulating an event changing with time and outputting information concerning the event to a user, which includes an input portion inputting an operation of the user, a transmission portion informing a server controlling the event of a change of the event generated by the operation of the user input to the input portion, a receiving portion receiving the change of the event generated in the other client terminals from the server, a processing portion simulating the event on the basis of the change, an output portion outputting the information concerning the event to the user, and a state change compensating portion computing the state of the event in the server on the basis of a delay time at the time when the change is informed from the server to the client terminal, and continuously changing the state of the event in the processing portion to the state of the event in the server.

The other aspect in accordance with the present invention relates to a client terminal. The client terminal is a client terminal simulating an event changing with time and outputting information concerning the event to a user, which includes an input portion inputting an operation of the user, a transmission portion informing a server controlling the event of a change of the event generated by the operation of the user input to the input portion, a receiving portion receiving the change of the event generated in the other client terminals from the server, a processing portion simulating the event on the basis of the change, an output portion outputting the information concerning the event to the user, and a time compensating portion quickening a time advance so as to catch up with a common time used in the server during the time until a predetermined time has passed after setting back a local time used in the processing portion at the time of receiving the change, by a delay time at the time when the change is informed from the server to the client terminal.

The other aspect in accordance with the present invention relates to a distributed processing method. The distributed processing method includes a step of simultaneously simulating an event changing with time in a plurality of terminals, a step of informing a second terminal of an event generated in a first terminal, a step of estimating a state of the event in the first terminal on the basis of a time required in the informing step, and a step of continuously changing a state of the event in the second terminal to the estimated state of the event in the first terminal.

As described later, a procedure of compensation described in FIG. 5 corresponds to a preferable embodiment utilizing this method.

The other aspect in accordance with the present invention relates to a distributed processing method. The distributed processing method includes a step of simultaneously simulating an event changing with time in a plurality of terminals, a step of informing a second terminal of an event generated in a first terminal, a step of acquiring the time at which the event should inherently finish by subtracting a time required for the information, in the second terminal, and a step of accelerating a change of a state constituting the event so that the event finishes at the time at which the event should inherently finish so as to remove an influence of time required for the information, in the second terminal.

As described later, a procedure of compensation described in FIG. 8 corresponds to a preferable embodiment utilizing this method. In this embodiment, start of the event corresponds to a motion of raising up a sword, and finish of the event corresponds to a motion of swinging down the sword. In order to synchronize the motion of swinging down the sword, a delay at a time of informing is compensated by executing the motion after raising up the sword until swinging down the sword faster than the normal one.

The other aspect in accordance with the present invention relates to a computer program. The program is operated in a certain terminal (hereinafter, referred to as own terminal), and is structured such that a step of simulating an event changing with time at the same time of the other terminals, a step of receiving an information of an event generated in the other terminals by an own terminal, a step of estimating a state of the event in the other terminals on the basis of a time required for the information, and a step of continuously changing the state of the event in the own terminal to the estimated state of the event in the other terminals are executed in a computer corresponding to the own terminal.

The other aspect in accordance with the present invention also relates to a computer program. The program is structured such that a step of simulating an event changing with time at the same time of the other terminals, a step of receiving an information of an event generated in the other terminals by an own terminal, a step of acquiring the time at which the event should inherently finish by subtracting a time required for the information, in the own terminal, and a step of accelerating a change of a state constituting the event so that the event finishes at the time at which the event should inherently finish so as to remove an influence of time required for the information, in the own terminal are executed in a computer corresponding to the own terminal.

In this case, optional combinations of the constituting elements mentioned above, and structures in which the expressions of the present invention are converted among the apparatus, the method, the system and the computer program are effective for the aspect in accordance with the present invention.

### BRIEF DESCRIPTION OF THE DRAWINGS

FIG. 1 is a view showing a whole structure of a distributed processing system in accordance with an embodiment;

FIG. 2 is a view showing a state in which an event generated within a processing server or a certain user terminal is informed to the other user terminals;

FIG. 3 is a view showing an internal structure of the processing server;

FIG. 4 is a view showing an internal structure of the user terminal;

FIGS. 5A, 5B, 5C and 5D are views for explaining an operation of a state change compensating portion;

FIG. 6 is a flow chart showing a compensating procedure in the state change compensating portion;

FIG. 7 is a view for describing an operation of a time compensating portion;

FIG. 8 is a view showing a state in which a time for processing an event is adjusted by the time compensating portion; and

FIG. 9 is a flow chart for explaining a compensating procedure in the time compensating portion.

### DESCRIPTION OF THE PREFERRED EMBODIMENT

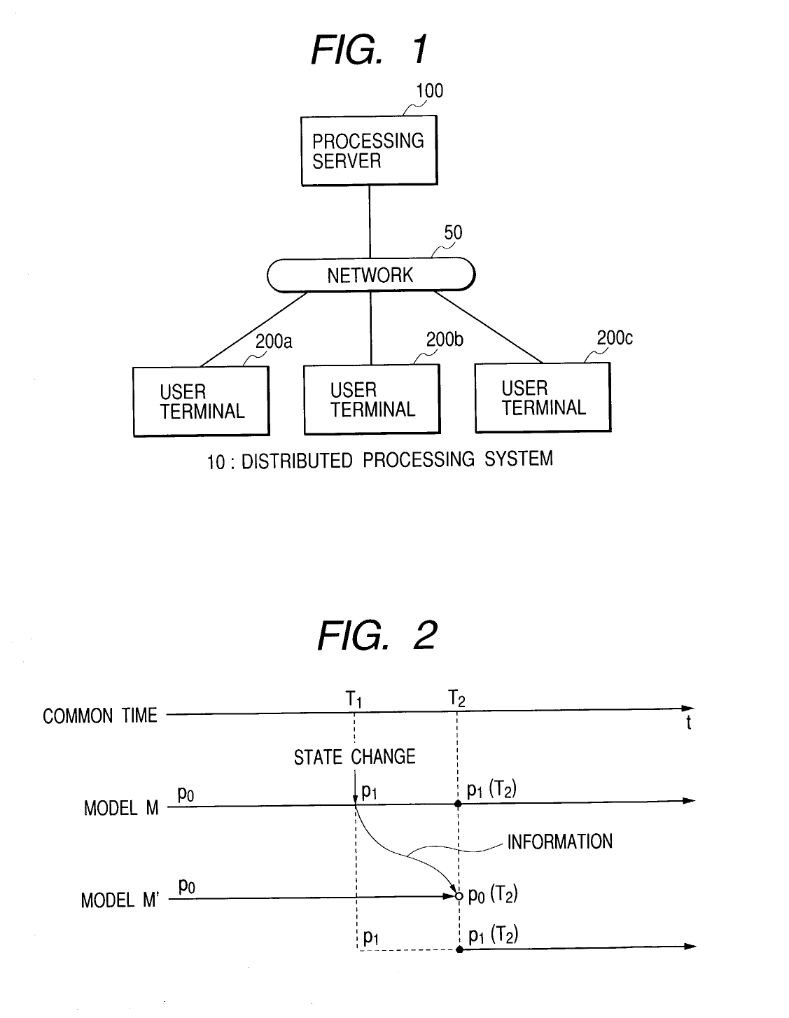

FIG. 1 is a whole structure of a distributed processing system 10 in accordance with an embodiment. In the distributed processing system 10, a processing server 100 and a plurality of user terminals 200 are connected via a network 50. The network 50 may be constituted by various kinds of wire communication such as an internet, a LAN, a WAN, a public network, a cellular phone packet network, a cable for exclusive use or the like, or various kinds of wireless communication utilizing electromagnetic waves or the like. The distributed processing system 10 in accordance with the present embodiment is utilized in a system in which a plurality of users commonly have an electronic space (hereinafter, also referred simply to as “space”) including an event changing with time, for example, a communication tool such as a network game, a chat system or the like, a car navigation system, a virtual reality, various kinds of simulations and the like. In the present embodiment, a description will be given by exemplifying the network game accordingly.

In the following description, the electronic space expressed in the distributed processing system 10 is simply referred to as the “space”. The space is constituted by a plurality of events changing with time. For example, in the case of the distributed processing system 10 achieving the racing game, the progressing game itself corresponds to the “space”. Further, a space in part constituting the space, that is, an object or an event provided within the space is also referred to as “model”, in the following description. For example, in the case of the racing game, each of vehicle bodies operated by the user corresponds to the model. Further, an event bringing a state change of the model is simply referred to as “event” in the following description. For example, in the case of the racing game, the event is generated by a handle operation, an accelerator operation, a brake operation and the like of the user. Of course, the event is not generated only by a user driven operation, but sometimes generated by a program constituting the system or an external factor.

In the distributed processing system 10 in accordance with the present embodiment, the processing server 100 does not unitarily control the space, but the respective user terminals 200 also simulate the space respectively. In the system in which the processing server 100 unitarily control the space, the respective user terminals 200 always observe the space within the processing server 100 via the network 50, and output a current state of the space to the users on the basis of a result of observation. At this time, since a certain degree of time is required for the communication with the processing server 100, it is liable that the delay is generated until an operation executed by the user terminals 200 is transmitted to the processing server 100, the space within the processing server 100 is renewed on the basis of the operation, and then the renewed result is reflected to the user terminals 200. Accordingly, it is not suitable for the system in which a change with time of the event occurs in a comparatively high speed and a real-time process is required, such as the racing game or the like.

On the contrary, in the distributed processing system 10 in accordance with the present embodiment, since the respective user terminals 200 themselves simulate the space, it is possible to receive the operation of the user in real time and to renew the space. For example, with respect to the event in which it is necessary to renew the space in real time, such as a handle operation, an accelerator operation and the like executed by the user in the racing game, a drawing process is executed with reflecting to the space within the respective user terminals 200 in real time. Accordingly, the user can enjoy the game without feeling the delay so much.

Of course, when the respective user terminals 200 independently renew the respective spaces, the respective spaces become completely different, so that it is necessary to synchronize in some way. In the distributed processing system 10 in accordance with the present embodiment, the events generated in the respective user terminals 200 are transmitted to the processing server 100, and the processing server 100 multicasts all the user terminals 200. Accordingly, the synchronization is taken between the space within the processing server 100 and the spaces within the respective user terminals 200.

That is, the event generated within the user terminal 200, which the individual user terminal 200 can independently process, is immediately reflected to the space within the user terminal 200. On the other hand, the event generated in the other user terminal 200 or the processing server 100 is transmitted to the user terminal 200 with some degree of communication delay, and is reflected to the space within the user terminal 200.

FIG. 2 shows the state in which the event generated within the processing server 100 or the particular user terminal 200 is informed to the other user terminals 200. In this case, reference symbols p₀ and p₁ denote a function of time t describing a state of the model. These are not limited to a scalar function, but may be a vector function, however, as a matter of convenience of the description, it is defined that the reference symbols p includes the vector function. It is assumed that a state of a model M within the processing server 100 changes from p₀ to p₁, at a particular time T₁. The state change is informed from the processing server 100 to the respective user terminals 200 all at once. The information from the processing server 100 reaches the respective user terminals 200 with some degree of delay in correspondence to the communication state of the network 50 between the processing server 100 and the respective user terminals 200. It is assumed that the information that the state change is generated reaches a model M′ within the particular user terminal 200 at a time T₂.

The state of the model M within the processing server 100 at the time T₂ is p₁(T₂), however, since a model M′ within the user terminal 200 progresses without knowing a matter that the state change occurs at the time T₁, a state of the model M′ at the time T₂ is p₀(T₂). When the information of the state change is given, the user terminal 200 computes a state p₁(T₂) of the model M′ at the time T₂ in accordance with a state function p₁ so as to renew the state of the model M′. Accordingly, it is possible to synchronize the model M′ within the user terminal 200 with the model M within the processing server 100. However, when changing the state of the model M′ from the state p₀(T₂) to the state p₁(T₂) at the time T₂, the state discontinuously changes, so that a moving object suddenly jumps to another place or a motion becomes discontinuous, whereby there is a possibility that an unnatural impression is given to the user.

Therefore, in accordance with the present embodiment, there is provided a method of reducing an unnaturalness by continuously changing the state of the model at a time of synchronizing the space provided in the processing server 100 with the spaces provided in the respective user terminals 200 in a distributed manner. Further, there is provided a method of compensating the time lag caused by the delay of the network.

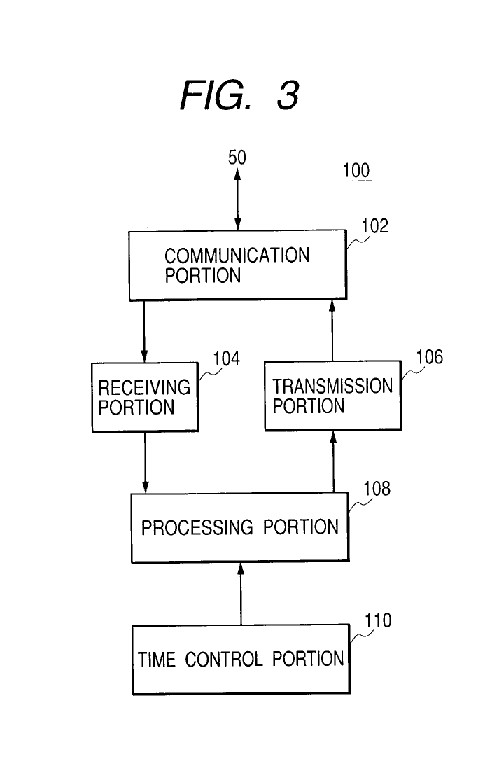

FIG. 3 shows the internal structure of the processing server 100. The processing server 100 includes a communication portion 102, a receiving portion 104, a transmission portion 106, a processing portion 108 and a time control portion 110. The communication portion 102 exchanges information with the user terminals 200. The communication portion 102 is provided with a hardware such as a modem or the like required for communication, and a driver or the other programs which controls the communication. The receiving portion 104 receives the events generated in the respective user terminals 200 so as to transmit to the processing portion 108. The transmission portion 106 transmits the events to the respective user terminals 200.

The processing portion 108 processes various kinds of events generated within the space, and simulates the space. This structure can be achieved by a CPU, a memory, a program loaded on the memory or the like in an optional computer, corresponding to hardware components, however, in this case, a function block achieved by association thereof is drawn. Accordingly, those skilled in the art can understand that this function can be achieved in various aspects by only a hardware, only a software or a combination thereof.

When the event is transmitted from the respective user terminals 200 via the receiving portion 104, the processing portion 108 renews the model on the basis of the information, and informs all the user terminals 200 of the renewed information via the transmission portion 106. The space simulated by the processing server 100 corresponds to a space constituting a reference within the distributed processing system 10. The processing portion 108 may control an event which is not individually processed by the respective user terminals 200 but unitarily controlled by the processing server 100, such as an event requiring an exclusion process, for example, an event in which a character takes up an item which exists only one in the role playing game. The time control portion 110 controls a common time which all the spaces in the processing server 100 and the respective user terminals 200 commonly use. The time control portion 110 may transmit a time synchronization signal to the respective user terminals 200, for the purpose of synchronizing the time with the respective user terminals 200.

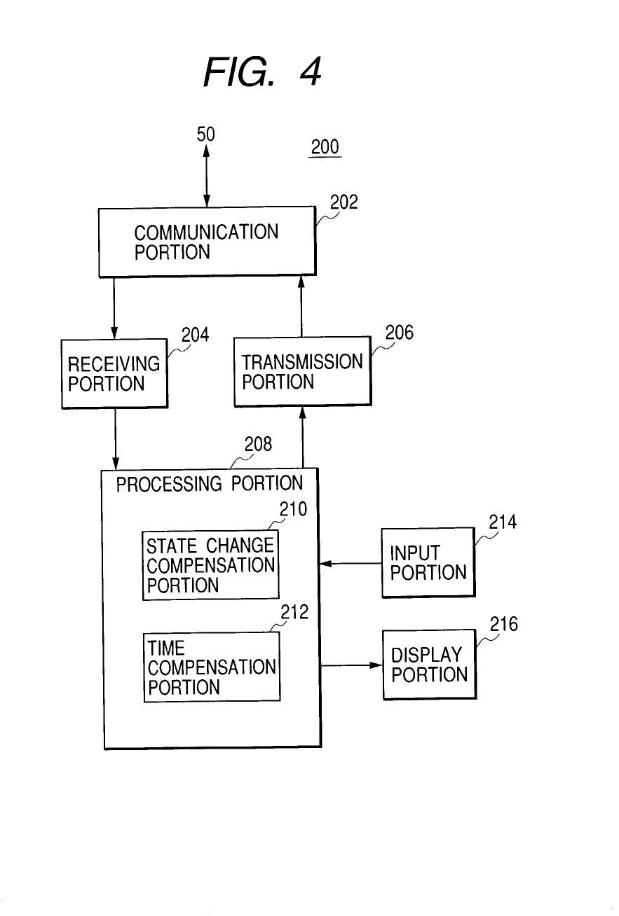

FIG. 4 shows the internal structure of the user terminal 200. The user terminal 200 includes a communication portion 202, a receiving portion 204, a transmission portion 206, a processing portion 208, an input portion 214 and a display portion 216. The communication portion 202 exchanges information with the processing server 100. The receiving portion 204 receives the events generated in the other user terminals 200 so as to transmit to the processing portion 208. The transmission portion 206 transmits the events generated in accordance with an operation of the user input to the input portion 214 to the processing server 100. The input portion 214 accepts command from the user which is input from an input device such as a mouse, a keyboard, a game controller or the like. The display portion 216 displays the information on a display device such as a display, a liquid crystal display device or the like.

The processing portion 208 processes various kinds of events transmitted from the processing server 100 or transmitted from the users via the input portion 214, and simulates the space. The processing portion 208 may execute the event generated in accordance with the operation input to the input portion 214 of its own terminal without waiting the information from the processing server 100. Accordingly, even when the event requires a rapid response, it is possible to execute it without delay. However, as mentioned above, with respect to the event having exclusivity, the generation of event is once transmitted to the processing server 100, and it is confirmed whether or not the execution is to be applied. The processing portion 208 includes a state change compensation portion 210 and a time compensation portion 212. This structure can be achieved in various aspects by only a hardware, only a software or a combination thereof.

The state change compensation portion 210 compensates a discontinuous state change of the model caused by the matter that the event information reaches in delay from the processing server 100. With reference to FIG. 2, a difference is generated between the state of the model M′ within the user terminal 200 and the state of the model M within the processing server 100 for the reason that the state change information reaches in delay from the processing server 100. In this case, in order to synchronize, when renewing from the state p₀(T₂) to the state p₁(T₂) at the time T₂, the state discontinuously changes, so that there is a possibility that an unnatural impression is given to the user. In this case, the state change compensating portion 210 continuously changes from the state p₀(T₂) to the state p₁(T₂) during a predetermined time. That is, the difference between the state p₀(T₂) and the state p₁(T₂) is gradually added during the predetermined period of time. For example, on the assumption that a compensation parameter d(t) is set as d(t)=(p₀(T₂)−p₁(T₂))×a^{(t-T}₂), is the state of p₁(t) continuously changed in accordance with a formula p₁, (t)=p₁(t)+d(t). In this case, a is an attenuation constant, and satisfies a relation 0<a<1. Since the compensation parameter d(t) is set so that a value is great immediately after the time T₂, and the value becomes smaller in accordance with an elapse of time, the change amount immediately after the time T₂ is great, however, is thereafter close to the state p₁(T₂) asymptotically, so that it is possible to give a natural impression to the users.

The compensation parameter d(t) may be structured such as to linearly change from the state p₀(T₂) to the state P₁(T₂), or may be structured such as to change in a curved manner in accordance with a high order polynomial function such as a quadratic function, a tertiary function and the like, an exponential function, or the other optional functions. In short, the structure may be made such that p′ (t) becomes equal to p(t)+(p₀(T₂)−p₁(T₂)) when the predetermined period of time has passed. In order to achieve a smooth state change, the state function p′(t) may be computed by approximating to a Bezier function, a spline function or the like.

The compensation as mentioned above may be applied only to the drawing process for displaying on the display portion 216, and the state function of the model M′ may be simply renewed from p₀ to p₁ at the time T₂. Accordingly, it is possible to provide a continuous change to the user, and it is possible to simplify the internal process. Further, the compensation parameter d(t) may be changed in correspondence to the kind of the state change and a condition of the space at that time. For example, under a condition in which the state change is frequently generated, it is possible to make the value of a great so as to quickly change the state for the purpose of following thereto, or under a condition in which the state change is hardly generated, it is possible to make the value of a small so as to slowly change the state. Further, when the state change relates to a speed or a coordinate of an object moving on the display screen, the structure is made such that the object smoothly moves by being approximated by the Bezier function, and when the state change is not directly provided to the user, such as a change of attribute value of the character or the like, the state may be discontinuously changed without executing the compensation.

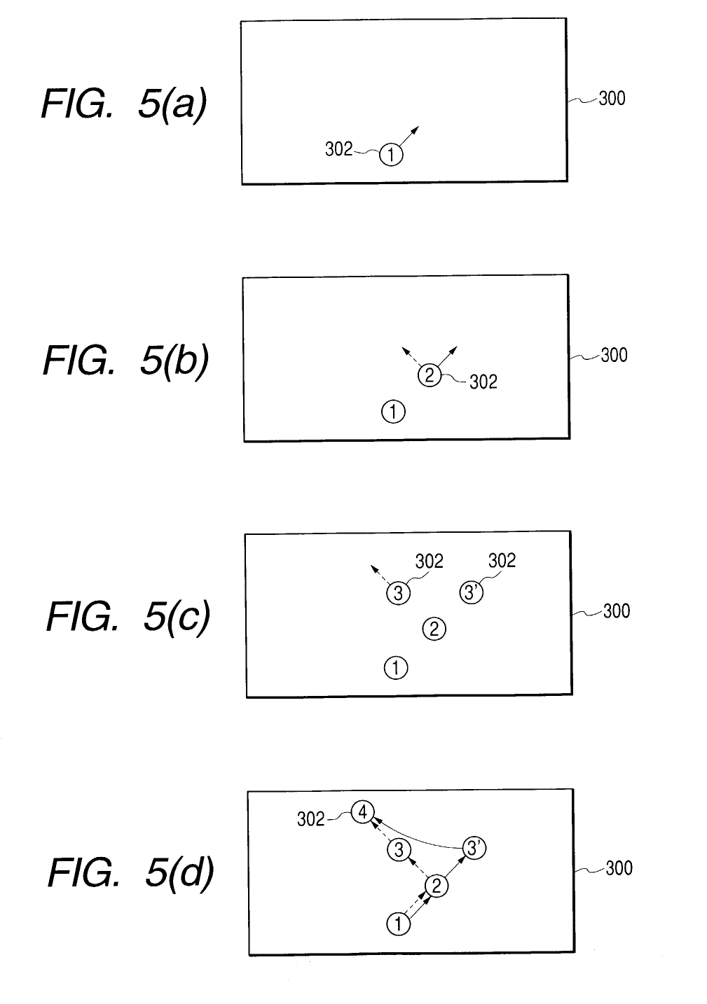

FIGS. 5A, 5B, 5C and 5D are views for describing an operation of the state change compensation portion 210. FIGS. 5A, 5B, 5C and 5D show a change with time of a position of an object 302 moving on a screen 300. FIG. 5A shows a position 1 of the object 302 at a time T₁. At this time, the object 302 is under moving in a right upward direction (a direction shown by a solid arrow in the drawing). FIG. 5B shows a position 2 of the object 302 at a time T₂. At this time, in the model M within the processing server 100, the moving direction of the object 302 is changed to a left upward direction (a direction shown by a broken arrow in the drawing). However, in the model M′ within the user terminal 200, the moving direction of the object 302 remains the right upward direction (the direction shown by the solid arrow in the drawing).

FIG. 5C shows a position of the object 302 at a time T3. In the model M′ within the user terminal 200, the object 302 reaches a position 3′, however, the position of the object 302 in the model M within the processing server 100 is 3. At this time, it is assumed that the user terminal 200 receives information that the moving direction of the object 302 is changed to the left upward direction at the time T₂, from the processing server 100. In this case, when changing the position of the object 302 from 3′ to 3, the object 302 suddenly jumps on the screen, thereby giving an unnatural impression to the user.

FIG. 5D shows a moving locus of the object 302 compensated by the state change compensation portion 210. The state change compensation portion 210 moves the object 302 from the position 3 to a position 4 during a period from the time T₃ to a time T₄. Accordingly, it is possible to synchronize with the state of the object 302 in the model M within the processing server 100 without jumping the coordinate. In FIG. 5D, a broken line shows a moving locus of the object 302 in the processing server 100, and a solid line shows a moving locus of the object 302 in the user terminal 200. The moving locus becomes slightly different due to an influence of the delay in communication, however, it is possible to reduce the influence of the delay by the compensation mentioned above.

In the embodiment shown in FIG. 5, the description is given of the state change of the object moving on the screen, however, with respect to the other optional state change, it is possible to compensate in accordance with the same method.

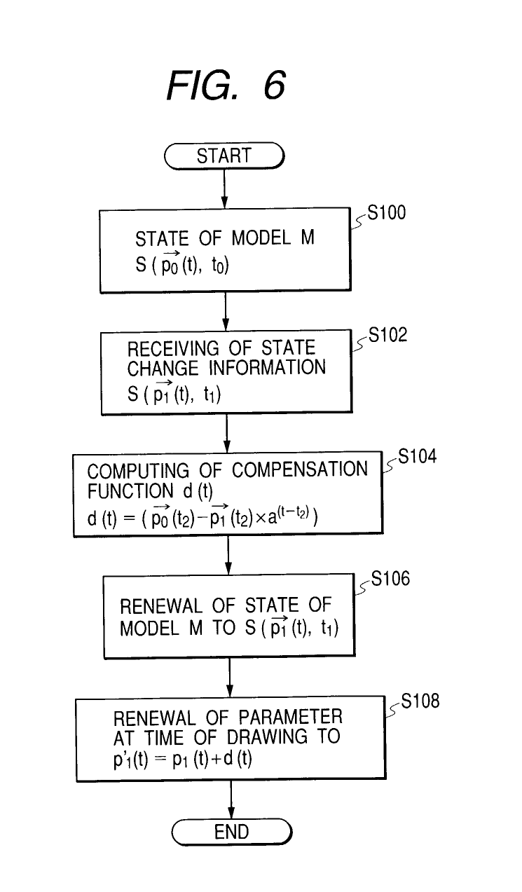

FIG. 6 is a flow chart showing a compensation procedure in the state change compensation portion 210. At first, it is assumed that in the user terminal 200, the model M is in a state shown by S(p₀(t), t₀) (S100). In this case, p₀(t) denotes a state function of the model M, and t₀ denotes an initial time. When the user terminal 200 receives a state change information S (p₁(t), T₁), from the processing server 100 (S102), the state change compensation portion 210 computes the compensation function d(t) (S104). Subsequently, the processing portion 208 renews the state of the model M to S(p₁(t) t₁) (S106), and renews a parameter p₁, (t) at a time of drawing (S108). Thereafter, the drawing process is executed by using the parameter p₁, (t), and a continuous state change is achieved in the drawing process.

Next, referring back to FIG. 4, a description will be given of the time compensation portion 212. The time compensation portion 212 compensates the time lag caused by the matter that the even information reaches in delay from the processing server 100.

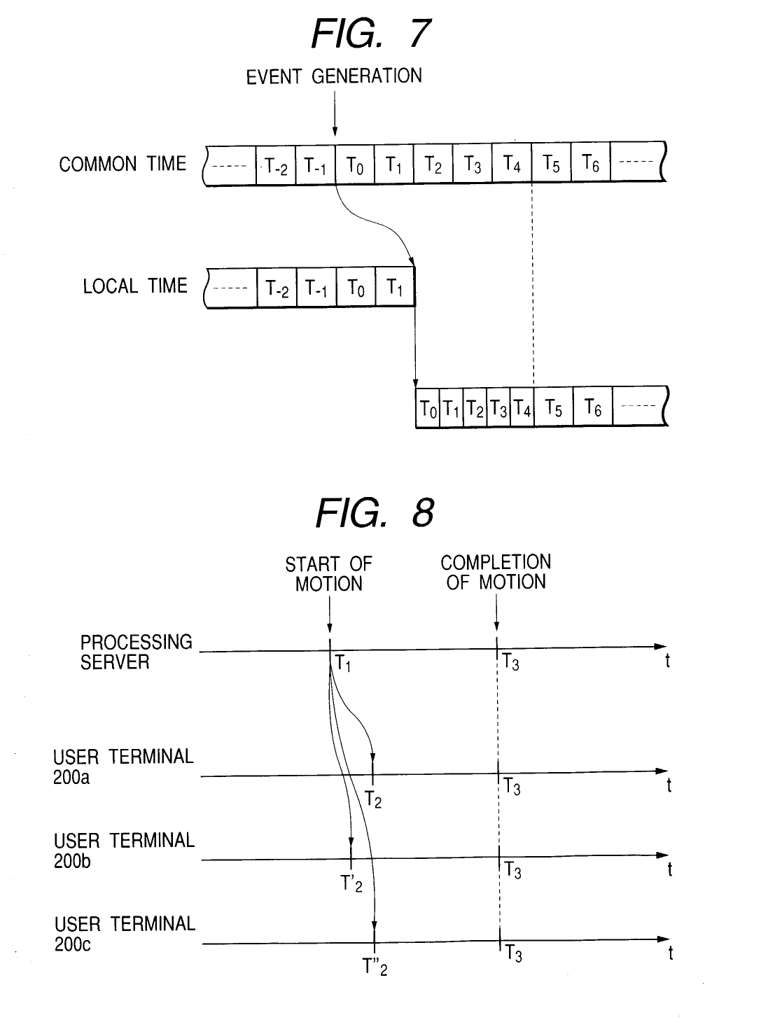

FIG. 7 is a view for describing an operation of the time compensation portion 212. It is assumed that the event is generated in the processing server 100 at a time To in the common time, and the information thereof reaches the user terminal 200 at the time T₂. At this time, the time compensation portion 212 sets back the local time to the time T₀, and instructs to the processing portion to start the processing of the event. Then, in order to catch up with the common time, it quickens the progressing degree of the time. In the embodiment shown in FIG. 7, the local time which has once delayed catches up with the common time at a time T₅. Accordingly, since the time control is executed by the time compensation portion 212 and the processing portion 208 can execute the event processing without being aware of the delay of time, it is easy to mount. When the delay of event information is great, the event immediately thereafter is to be executed at a higher speed than an actual speed, however, the set-back time and the time until catching up with the common time may be designed in a degree giving no unnatural impression to the user in correspondence to the kind of the event and the condition of the space at that time. The time compensation portion 212 may control the time model by model and may set back only the time of the model to which the event is informed, or may set back the time of the whole of the space within the user terminal 20.

FIG. 8 is a view showing a state in which the time for processing the event is adjusted by the time compensation portion 212. It is assumed that at the time T₁ in the common time, the event is generated in the processing server 100, and the information thereof reaches a user terminal 200a at the time T₂, a user terminal 200b at a time T₂′, and a user terminal 200c at a time T″, respectively. At this time, in the case that the time required after starting the motion until finishing the motion is previously known, the time compensation portion 212 in each of the user terminals 200 computes an estimated time T₃ that a motion will finish, and adjusts the time progressing so that the motion finishes by that time. For example, when a plurality of game machines connected a the network are arranged laterally, an audience seeing the state of the game behind players can simultaneously see the screens of all the game machines. At this time, in the embodiment mentioned above, a start of a certain motion, for example, a timing at which a motion of raising up a sword is started is slightly different among the respective game machines due to the delay of communication, however, a finish of the motion, for example, a timing at which the sword is swung down can be synchronized in all the game machines. Therefore it is possible to reduce an unnaturalness due to the delay.

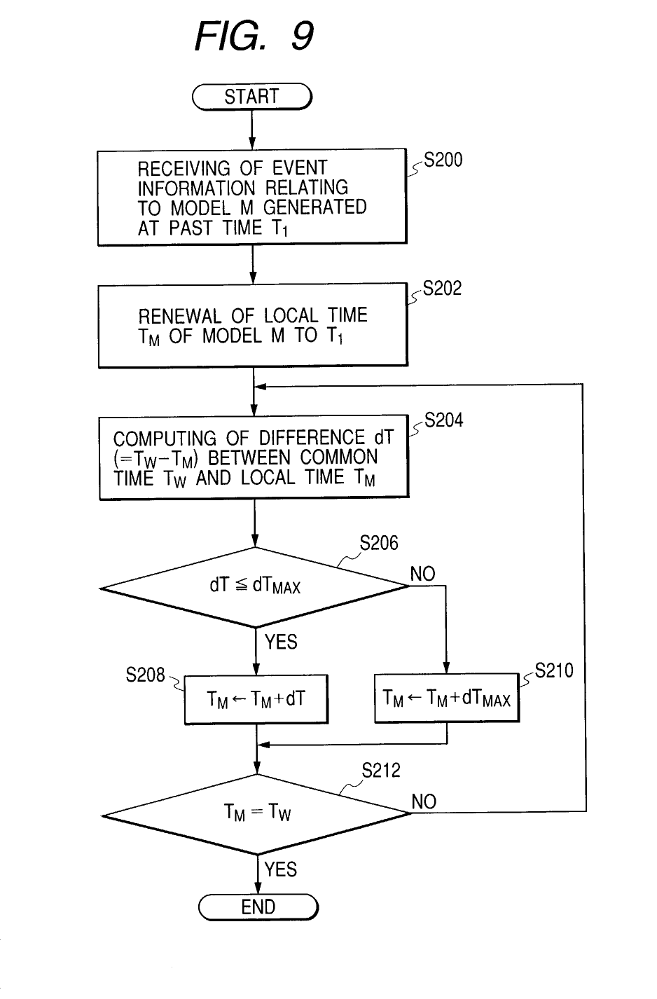

FIG. 9 is a flow chart for describing the compensation procedure in the time compensation portion 212. At first, the user terminal 200 receives the event information relating to the model M generated at the past time T₁ (S200). Then, the time compensation portion 212 renews a local time TM of the model M to T₁ (S202). Subsequently, the time compensation portion 212 computes a difference dT(=TW−TM) between a common time TW and the local time TM (S204), and when dT is equal to or less than a maximum value dTMAX of the time capable of being compensated at one step (Y in S206), the time compensation portion 212 adds dT to the local time TM (S208). When dT is larger than dTMAX (N in S206), the time compensation portion 212 adds dTMAX to the local time TM (S210). When the local time TM becomes equal to the common time TW (Y in S212), the compensation process is finished. When the local time TM does not catch up with the common time TW (N in S212), the step goes back to S204, and the compensation process is repeated.

As mentioned above, in accordance with the distributed processing system 10 of the present embodiment, the space is also simulated in the respective user terminals 200, whereby it is possible to rapidly reflect the event generated in the own terminal to the space. Further, with respect to the event transmitted via the network, it is possible to reduce the influence of delay in accordance with the compensation process. Further, since the process is distributed, it is possible to prevent the load from being concentrated to the processing server 100, whereby it is possible to prevent the performance from being deteriorated.

As mentioned above, the present invention is described on the basis of the embodiment. This embodiment is given for exemplification, and it is possible to be understood by those skilled in the art that various modified embodiments can be made by a combination of the respective constituting elements and the respective processes, and that such modified embodiments are within the scope of the present invention.

In the embodiment, the processing server 100 acquires the event generated in the respective user terminals 200, and broadcasts them to all the user terminals 200. However, the structure may be made such that the processing server 100 is not provided and any of user terminals 200 has the same function as the processing server 100. Further, the user terminal 200 itself may inform the other user terminals 200 of the generation of the event.

In the embodiment, the processing server 100 has the time control portion 110 controlling the common time, however, this may be provided in the respective user terminals 200.

In accordance with the present invention, in the distributed processing system, it is possible to provide a technique which reduces the influence of delay generated due to the communication.

What is claimed is:

1. A distributed processing system including a server and a plurality of client terminals and simulating an event changing with time, wherein
when “first” denotes structures relating to the server and “second” denotes structures relating to the client terminals,
the server controls the event,
the client terminals simulate the event and output information concerning the event to users,
the client terminal comprises:
a second transmission portion informing the server of a change of the event generated by operation of the users,
the server comprises:
a first receiving portion receiving the change informed from the plurality of client terminals;
a first processing portion simulating the event on the basis of the change; and
a first transmission portion informing the respective client terminals of the change informed from one client terminal, and
the client terminals further comprises:
a second receiving portion receiving the change from the server;
a second processing portion simulating the event on the basis of the change; and
a state change compensating portion computing a state of the event in the first processing portion on the basis of a delay time at the time when the change is informed from the server to the client terminals and continuously changing the state of the event so as to synchronize the state of the event in the second processing portion with the state of the event in the first processing portion.

2. A distributed processing system including a server and a plurality of client terminals and simulating an event changing with time, wherein
when “first” denotes structures relating to the server and “second” denotes structures relating to the client terminals,
the server controls the event,
the client terminals simulate the event and output information concerning the event to users,
the client terminal comprises:
a second transmission portion informing the server of a change of the event generated by operation of the users,
the server comprises:
a first receiving portion receiving the change informed from the plurality of client terminals;
a first processing portion simulating the event on the basis of the change; and
a first transmission portion informing the respective client terminals of the change informed from one client terminal, and
the client terminals further comprises:
a second receiving portion receiving the change from the server;
a second processing portion simulating the event on the basis of the change; and
a time compensating portion quickening a time advance so as to catch up with a common time used in the first processing portion during the time a predetermined time has passed after setting back a local time used in the second processing portion at a time of receiving the change, by a delay time at the time when the change is informed from the server to the client terminals.

3. A distributed processing system as claimed in claim 2, further comprising a state change compensating portion computing a state of the event in the first processing portion on the basis of the delay time and continuously changing the state of the event in the second processing portion to a state of the event in the first processing portion.

4. A distributed processing system as claimed in any one of claims 1 to 3, wherein the client terminal is structured such that the second processing portion reflects the change on the simulation before receiving the change of the event generated by the operation of the user, from the server.

5. A client terminal simulating an event changing with time and outputting information concerning the event to a user, comprising:
an input portion inputting an operation of the user;
a transmission portion informing a server controlling the event of a change of the event generated by the operation of the user input to the input portion;
a receiving portion receiving the change of the event generated in the other client terminals from the server;
a processing portion simulating the event on the basis of the change;
an output portion outputting the information concerning the event to the user; and
a state change compensating portion computing the state of the event in the server on the basis of a delay time at a time when the change is informed from the server to the client terminal, and continuously changing the state of the event in the processing portion to the state of the event in the server.

6. A client terminal simulating an event changing with time and outputting information concerning the event to a user, comprising:
an input portion inputting an operation of the user;
a transmission portion informing a server controlling the event of a change of the event generated by the operation of the user input to the input portion;
a receiving portion receiving the change of the event generated in the other client terminals from the server;
a processing portion simulating the event on the basis of the change;
an output portion outputting the information concerning the event to the user; and
a time compensating portion quickening a time advance so as to catch up with a common time used in the server during the time until a predetermined time has passed after setting back a local time used in the processing portion at the time of receiving the change, by a delay time at the time when the change is informed from the server to the client terminal.

7. A distributed processing method comprising:
a step of simultaneously simulating an event changing with time in a plurality of terminals;
a step of informing a second terminal of an event generated in a first terminal;
a step of estimating a state of the event in the first terminal on the basis of a time required in the informing step; and
a step of continuously changing a state of the event in the second terminal to the estimated state of the event in the first terminal.

8. A distributed processing method comprising:
a step of simultaneously simulating an event changing with time in a plurality of terminals;
a step of informing a second terminal of an event generated in a first terminal;
a step of acquiring the time at which the event should inherently finish by subtracting a time required for the information, in the second terminal; and
a step of accelerating a change of a state constituting the event so that the event finishes at the time at which the event should inherently finish so as to remove an influence of time required for the information, in the second terminal.

9. A computer program to execute steps in a computer comprising:
a step of simulating an event changing with time at the same time of the other terminals;
a step of receiving an information of an event generated in the other terminals by an own terminal;
a step of estimating a state of the event in the other terminals on the basis of a time required for the information; and
a step of continuously changing the state of the event in the own terminal to the estimated state of the event in the other terminals.

10. A computer program to execute steps in a computer comprising:
a step of simulating an event changing with time at the same time of the other terminals;
a step of receiving an information of an event generated in the other terminals by an own terminal;
a step of acquiring the time at which the event should inherently finish by subtracting a time required for the information, in the own terminal; and
a step of accelerating a change of a state constituting the event so that the event finishes at the time at which the event should inherently finish so as to remove an influence of time required for the information, in the own terminal.
